(19) United States
(12) Patent Application Publication
(10) Pub. No.: US 2007/0028978 A1
(43) Pub. Date: Feb. 8, 2007

(54) Innovative valve mechanism for detergent dispenser

(76) Inventor: Shwu Yueh Jeng, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/194,646

(22) Filed: Aug. 2, 2005

(51) Int. Cl. F16K 15/14

(52) U.S. Cl. 137/854

(57) ABSTRACT

An innovative valve mechanism for a detergent dispenser comprise a valve tube unit, a mobile valve unit, a liquid outlet; thereby, a simplified design of assembled valve mechanism to significantly reduce cost, labor and working hours, for accurate control of liquid flow and perfect stopping efficiency.

### BACKGROUND OF THE INVENTION

1. Field of the Invention

The present invention relates to an innovative valve mechanism for a detergent dispenser, particularly a design of simplified structure of valve assembly to significantly reduce cost and labor, for accurate control of liquid flow and stoppage.

2. Description of the Prior Art

Detergent dispensers can be easily seen on one side of washstands in public restrooms, which provides detergent for the public to wash their hands after using the facilities.

Referring to FIG. 1 shows a perspective view of some essential parts of the prior art of the detergent dispenser. As shown, a liquid tank 10 filled with detergent is connected with a liquid tube 20. At one end of the liquid tube 20 is a liquid outlet 30. Wherein, referring to FIGS. 2, 3 and 4, the liquid outlet 30 has a valve structure involving an upper casing 301 having a hole 301a and a liquid outlet 30. Disposed between the upper casing 301 and the liquid outlet 30 is a valve block 302 and a spring 303, the valve block 302 being pushed upward by the spring 303 against the hole 301a to prevent a liquid leak. To get access to the detergent, the user can use infrared ray activation or manually push open an outlet to squeeze the liquid tube 20, forming powerful liquid pressure to push the valve block 302 downward and away from the stopping position, forming a space to allow the detergent to flow down and out of the liquid outlet 30.

However, there is quite a wide variety of valve assemblies of the aforementioned liquid outlet 30, which molds are at high costs and which assembling processes are quite time and labor consuming; furthermore, after extended use of the assembly, the liquid within would often leak out.

To address the above shortcomings, the present inventor has dedicated intensive study and experiments and has come up with the present invention that is more simplified in structure, more advanced in inventive steps, and capable of significantly reducing costs and labor.

### SUMMARY OF THE INVENTION

The present invention relates to an innovative valve mechanism for detergent dispenser, referring to FIGS. 5, 6A, 6B, 7 and 8 comprise a valve tube unit 40, a mobile valve unit 50, and a liquid outlet 60, wherein, provided inside the valve tube unit 40 is a partition board 40a, below the partition board 40a is a formation of a valve tank 40b; provided in the middle of the partition board 40a is a through hole 401, with a specified number of liquid holes 402 on its periphery. And, a mobile valve unit 50 is a flexible unit having a high flexibility, in the shape of an arched valve plate 501, wherein is an extension of a post unit 502; provided at a specified height of the post unit 502 is a protruded ring unit 503.

Wherein, the valve tank 40b is optionally a depressed tank in one of a variety of configurations; the valve plate 501 of the mobile valve unit 50 is made in a shape to match the configuration of the valve tank 40b.

### BRIEF DESCRIPTION OF THE DRAWINGS

FIG. 1 is a perspective view of the essential parts of a prior art of the detergent dispenser.

FIG. 2 is an exploded view and a perspective view of the prior art of the detergent dispenser showing its liquid outlet and valve mechanism.

FIG: 3 is a section view of the prior art of the detergent dispenser showing its liquid outlet and valve mechanism blocking the detergent therein.

FIG. 4 is a section view of the prior art of the detergent dispenser showing its liquid outlet and valve mechanism squeezing the detergent therein.

FIG. 5 is a top view of the valve tube unit and mobile valve unit of the present invention.

FIG. 6A is a bottom view of the valve tube unit and mobile valve unit of the present invention.

FIG. 6B is a front view of the valve tube unit and mobile valve unit of the present invention.

FIG. 7 is a perspective section view of the valve tube unit and mobile valve unit of the present invention taken from the line marked A-A.

FIG. 8 is a perspective section view and exploded view of the present invention of the innovative valve mechanism.

FIG. 9 is a section view of the present invention showing the valve mechanism blocking the detergent.

FIG. 10 is a section view of the present invention showing the valve mechanism squeezing out the detergent.

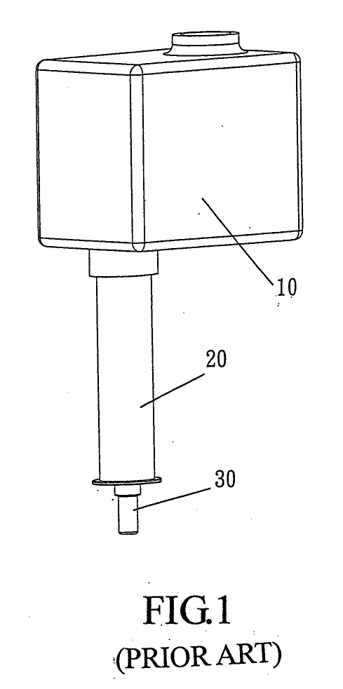

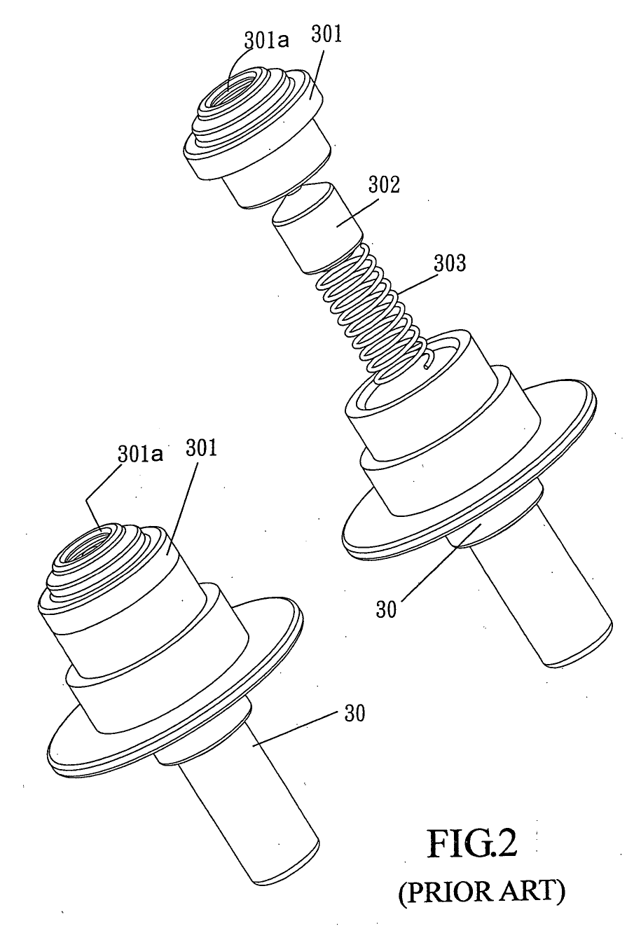

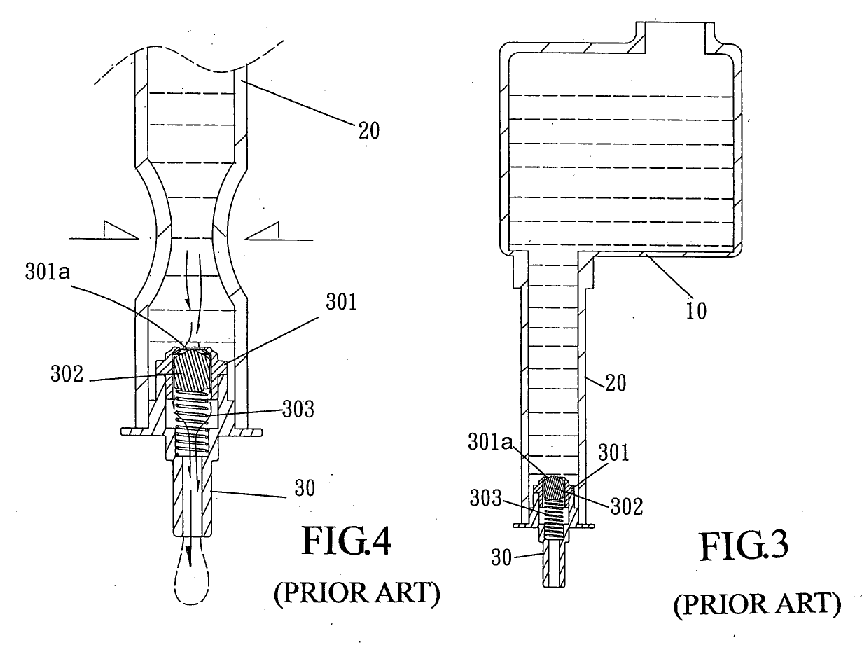

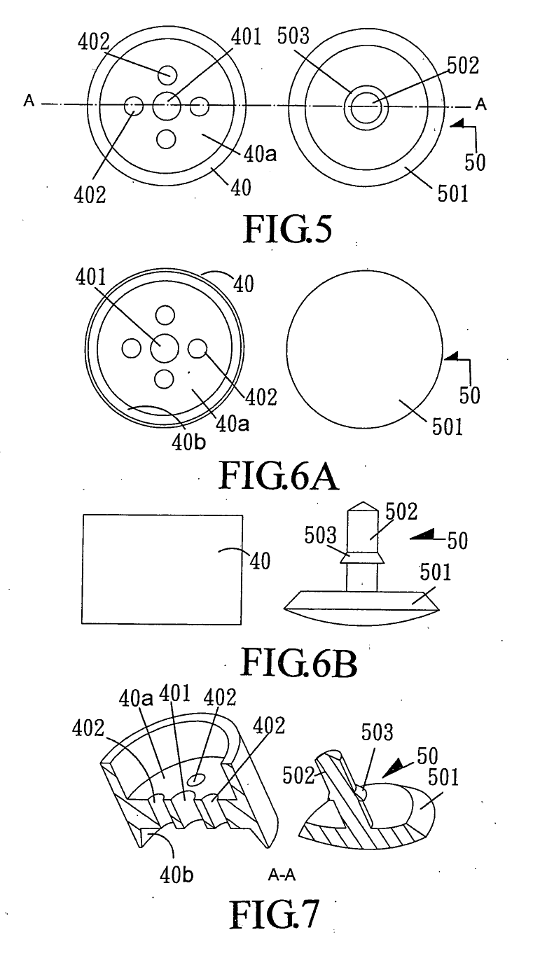

### DETAILED DESCRIPTION OF THE PREFERRED EMBODIMENT

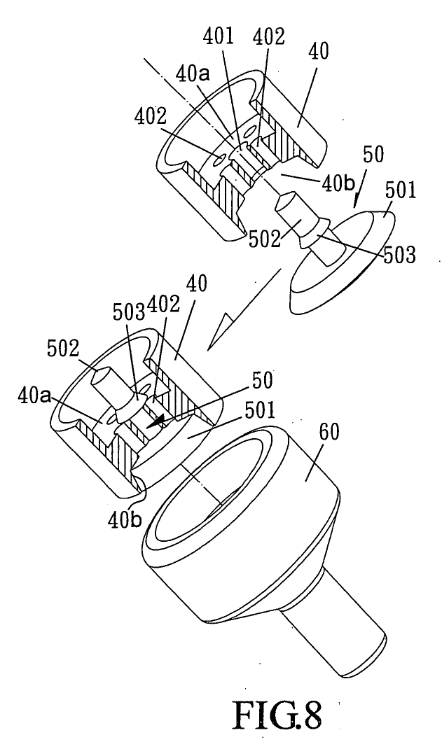

Referring to FIG. 8 is a perspective section view of the present invention of innovative valve mechanism. As shown, a post unit 502 of a mobile valve unit 50 runs through a through hole 401 on a partition board 40a, having a protruded ring 503 fastened onto the partition board 40a, wherein, a valve plate 501 is pulled upward by the post unit 502 in the middle, its surface completely sealing the valve tank 40b to block the liquid hole 402, then, a liquid outlet 60 and a valve tube unit 40 are combined to form a valve mechanism.

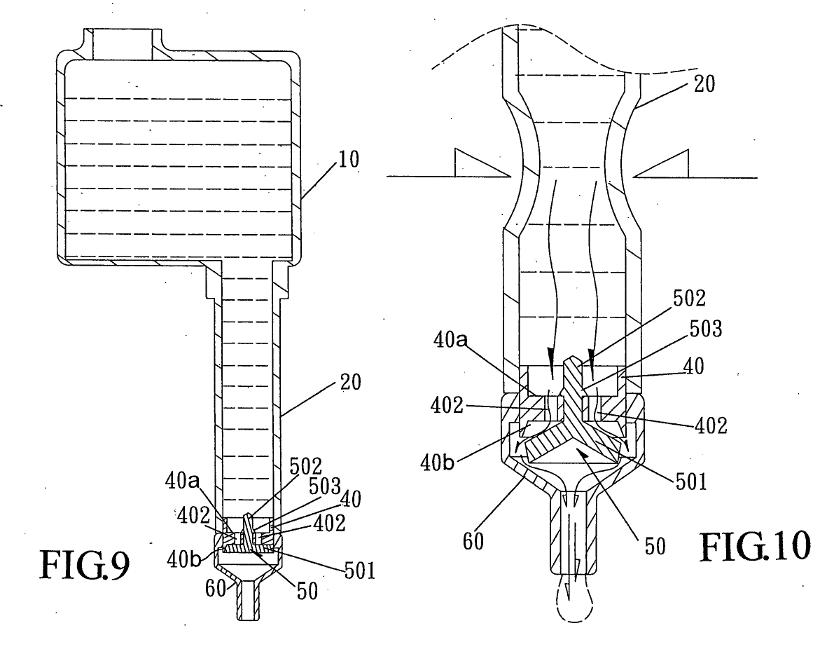

Referring to FIG. 9 is a section view of the present invention of valve mechanism blocking the detergent. As shown, the liquid tank 10 serves to contain the detergent. The detergent flowing through the liquid tube 20 to all liquid holes 402 of the valve tube unit 40, where the detergent is blocked by the valve plate 501 of the mobile valve unit 50 pressing against the valve tank 40b and could not flow out (refer to FIG. 10). To squeeze out the detergent, the user can press the switch on the detergent dispenser to squeeze the liquid tube 20. Then, the detergent inside the liquid tube 20 forms a powerful liquid pressure to flow through the liquid holes 402 and squeeze the valve plate 501 downward and away from its blocking position, forming an open space to allow smooth flow of detergent from the liquid outlet 60. And, after the user stops squeezing the liquid tube 20, the valve plate 501 bounces back to block the liquid holes 402 and stops the detergent from flowing out.

As described above, the simplified structure and perfect structural performance of the present invention is capable of significantly reducing costs, saving labor and enhancing production efficiency, and because it is not yet disclosed for public use, satisfactory to the requirements of applicability and novelty, this application is duly filed for a patent right. Your favorable consideration will be appreciated.

It should be understood that the above description is used merely to explain the preferred embodiment of the present intention, and that all equivalent modifications and variations made by anyone skilled in the art without departing from the spirit of the subject description and drawings should be included in the subject claim.

What the invention claimed is:

1. An innovative valve mechanism for a detergent dispenser, comprising a valve tube unit, a mobile valve unit, a liquid outlet, wherein, provided in the middle of the valve tube unit is a partition board, under the partition board is a formation of a valve tank, in the middle of the partition board is a through hole, on a periphery of the partition board is a specified number of liquid holes; and a mobile valve unit which is a highly flexible unit having resiliency, a valve plate having an arched surface, wherein there is an extension of a post unit, and at a specified height of the post unit being provided with a protruded ring;
wherein, the valve tank is optionally a depressed tank in various configurations, and the valve plate of the mobile valve unit is shaped to match the configuration of the valve tank;
thereby, the post unit of the mobile valve unit penetrates a specified number of through holes on the partition board, and the protruded ring is fastened onto the partition board, wherein, the valve plate is pulled upward by the post unit to seal completely onto the valve tank and blocks all liquid holes; there is also a liquid outlet combined with the valve tube unit to form a valve mechanism.
